(19) United States
(12) Patent Application Publication
(10) Pub. No.: US 2010/0284526 A1
(43) Pub. Date: Nov. 11, 2010

(54) REMOTE MONITORING AND CONTROL APPARATUS

(76) Inventor: Maurice Dempsey, West Kirby (GB)

Correspondence Address: PRASS LLP, 2661 Riva Road, Bldg. 1000, Suite 1044, ANNAPOLIS, MD, 21401, US

(21) Appl. No.: 12/446,803

(22) PCT Filed: Oct. 23, 2007
(86) PCT No.: PCT/GB07/50650

§ 371 Date: Jul. 28, 2010

(30) Foreign Application Priority Data
Oct. 23, 2006 (GB) 0621009.0

(51) Int. Cl. H04M 11/00

(52) U.S. Cl. 379/102.07; 379/102.01

(57) ABSTRACT

A remote monitoring and control apparatus (10) comprises a receiver (74) adapted to receive one or more input signals (76) and provide one or more output signals for displaying content on a monitor (12); a telephony unit (26, 62, 64) for connecting a remote telephone (42) to a local interface (36, 38, 56) using a telephony signal; and a processing unit (60) operatively connected to the receiver (74) and the telephony unit (26, 62, 64), wherein the processing unit (60) is adapted to detect an incoming call (44) from the remote telephone (42) and in response thereto automatically; allocate and open a voice channel (70) of the telephony signal over which a user (20) of the remote telephone (42) and a user (18) of the local interface (36, 38, 56) can converse; and allocate and open a control channel (72) of the telephony signal over which the user (20) of the remote telephone (42) can send control signals (72) to control the operation of the receiver (74).

This invention relates to a remote monitoring and control apparatus.

Elderly and/or disabled people sometimes have to live in care institutions (e.g. care homes, hospitals or hospices) where their particular health and social welfare needs can be best catered for. Many people in such institutions suffer from disorders, such as dementia, that render them unable to comprehend their surroundings, remember important information or interact with others.

It is estimated that for up to 40% of people living in Britain's care homes, the main source of entertainment is television. However, a larger proportion of those people are unable to operate a television or telephone, which means they can be left for days, watching the same television channel without being able to change it. Further, they might not be able to adjust the volume or switch the set on or off, which can be intensely irritating and can interfere with sleep patterns etc.

This invention aims to provide a solution to one or more of the above problems.

According to the invention, a remote monitoring and control apparatus is provided comprising; a receiver adapted to receive one or more input signals and provide one or more output signals for displaying content on a monitor; a telephony unit for connecting a remote telephone to a local interface using a telephony signal; and a processing unit operatively connected to the receiver and the telephony unit, wherein the processing unit is adapted to detect an incoming call from the remote telephone and in response thereto automatically; allocate and open a voice channel of the telephony signal over which a user of the remote telephone and a user of the local interface can converse; and allocate and open a control channel of the telephony signal over which the user of the remote telephone can send control signals to control the operation of the receiver.

The receiver is adapted to receive one or more input signals, which can be of any type, although a preferred receiver is adapted to receive digital and/or analogue television signals. The input signals can be received by the receiver from any available source, such as satellite transmissions, optical or electrical cable broadcasts, terrestrial television broadcasts and/or internet data transfer (including broadband and/or voice-over-internet (VOI) signals). The output signal of the receiver is preferably suitable for displaying content, such as television programs, text messages etc., on a suitable monitor, such as a television set or a computer screen. Thus, the output signal can comprise any one or more of the following signals: RGB, audio, composite audio-visual (AV), high definition television (HDTV) and/or digital video (DV).

A telephony unit is provided for communicating with the remote telephone. The telephony unit preferably comprises a modem. The telephony unit modem is, preferably, adapted to allow two-way communication between a remote user and a local user. The modem can be of a standard analogue-to-digital type, although a broadband modem is preferred since it provides increased bandwidth and therefore facilitates the transfer of multimedia signals, rather than simply voice signals.

The processing unit is adapted to detect an incoming call from the remote telephone and in response thereto automatically open a voice channel over which a remote user and a local user can converse. Once the voice channel has been opened, received signals (i.e. the remote user's voice) is outputted audibly. For this, the monitoring and control apparatus may have an integral speaker, or the audible signal may be monitored using a connected device, such as a television set. The monitoring and control apparatus is preferably operatively connected to a microphone to enable the local user's voice to be picked-up and sent over the telephone line to remote user. In effect, one function of the control circuit is to provide a hands-free telephone set at the local user's premises, which automatically picks-up on receipt of an incoming call. Additionally or alternatively, a conventional telephone handset may be provided, that the local user can hold to conduct the telephone conversation, which might feel more natural and/or be more convenient to certain types of user.

Before the processing unit accepts an incoming call, it is preferred that the incoming call be announced to enable the local user to prepare and/or decide whether or not to take the call. Thus, an audible and/or visible signal, such as a buzzer and/or a flashing light, is preferably associated with the monitoring and control apparatus to announce incoming calls to the local user. In one possible embodiment, the announcement of an incoming call can be made using an attached device. For example, an incoming call could be announced by displaying an overlaid text message on a connected television set along with an audible warning, such as muting the television and/or a beep. Muting an attached television, or live-pausing of the program being watched, on receipt of an incoming call is a highly preferred feature, since it enables the local user to properly hear the voice of the remote user, rather than having to listen over the noise of the television set.

An accept and/or decline call button is optionally provided to enable the local user to accept or decline incoming calls manually.

When an incoming call is received, a control channel is opened over which the remote user can send control signals to control the operation of the receiver. To accomplish this, the processing unit may designate a portion of the available bandwidth of the telephone line for control signals. In one possible embodiment, the voice signal is chopped above or below the audible range of the local user, and the chopped portion of the bandwidth can be used to transmit and receive control signals. In an alternative embodiment, the control signals are interlaced with the voice signals by compressing them and sending them as short (e.g. microsecond) bursts over the voice channel. Since the burst length can be made very short, the burst is not heard or detected by the users of the apparatus.

In another possible embodiment, the remote user can use pre-defined key sequences on his telephone handset to send Dual Tone Multi Frequency (DTMF) tones to the monitoring and control apparatus. Upon receipt of the DTMF tones, certain controls can be affected, such as changing channel, programming a video recording device (e.g. Sky Television's® “autoview”), adjusting the volume, putting the set in, or taking it out of, standby mode setting an on/off timer etc.

Preferably, the remote user's telephone can be pre-loaded with software having a Graphical User Interface (GUI) that contains menus of control signals for the set-top box (STB). Such a configuration may enhance the functionality of the system, and/or make it more user-friendly.

Using such system, the remote user may be able to browse the menus for suitable control signals, rather than having to remember key sequences for each control function. Advantageously, a menu-driven system enables controls to be categorised, thereby making them easier to navigate and/or find. For example, there may be a top-level menu of all commands, and various sub-menus containing, for example: basic television control commands (“volume up”, “volume down”, “channel up”, “channel down” etc.); STB programming commands (“change to channel “x” at a certain time”, “record program “y” on the digital/personal video recorder (PVR)”, “purge PVR” (i.e. delete all recorded programs from the PVR that have been watched), etc.); organiser commands (e.g. “set/unset on-screen reminders”, “view log of acknowledged/ignored reminders”, etc.); and so forth.

Advantageously, by using a GUI with pre-defined multiple-digit codes, it is possible to expand the functionality of the system enormously. For example, using a 4-digit code system enables up to ten-thousand discrete commands to be sent, rather than just the ten that would be available if only single-digit DTMF tones from 0 to 9 were used.

The remote user can browse the menus on his/her telephone and select an appropriate control command. By highlighting the desired command and pressing send, a pre-defined DTMF sequence can be sent as a microsecond burst over the voice channel to the STB, which interprets the incoming burst using pre-loaded software and actions the command.

The output of the monitoring and control apparatus can be a cable or wire that can connect to a television set or computer monitor using industry-standard connection, such as, but without limitation to a Syndicat des Constructeurs d'Appareils Radiorécepteurs et Téléviseurs (SCART) plug, a coaxial cable, a Deutsches Institut für Normung (DIN) plug, phono leads etc.

The telephone network can be a digital or analogue, landline or mobile network. The monitoring and control apparatus of the invention may make use of additional telephone network services, such as text messaging using a Short Message Server (SMS) or third-generation (3G) multimedia content.

The monitoring and control apparatus preferably has a security protocol associated therewith. The security protocol may simply comprise a caller ID associated with the modem for identifying the incoming telephone number and only automatically accepting calls from pre-defined telephone numbers. (The caller ID may be displayed on the monitor so that the local user can screen is incoming calls if desired). More preferably, the remote user will have to enter a unique Personal Identification Number (PIN) to be able to connect to the apparatus. The PIN number can be defined on the local user's apparatus, or they may be defined in a third party system. In the latter case, the remote user will need to telephone the third party (e.g. a call centre) and ask to be put through to the local user. Once the remote user has satisfied the third party that they are entitled to connect to the local user, the call will be put through. Using a third party intermediary enables incoming calls to be billed at custom rates and/or the local user to be able to subscribe to additional services, such as pay-per view programs or subscription television channels.

Preferred embodiments of the invention are described below with reference to the accompanying drawings, in which:

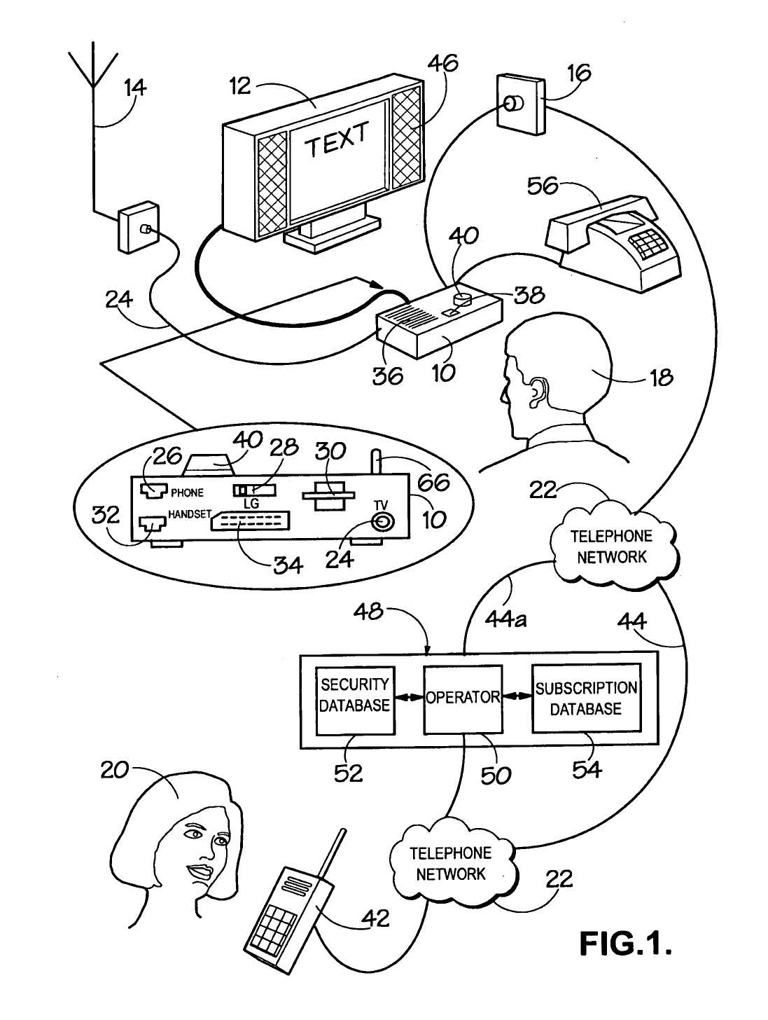

FIG. 1 is a schematic showing a remote monitoring and control apparatus in accordance with the invention;

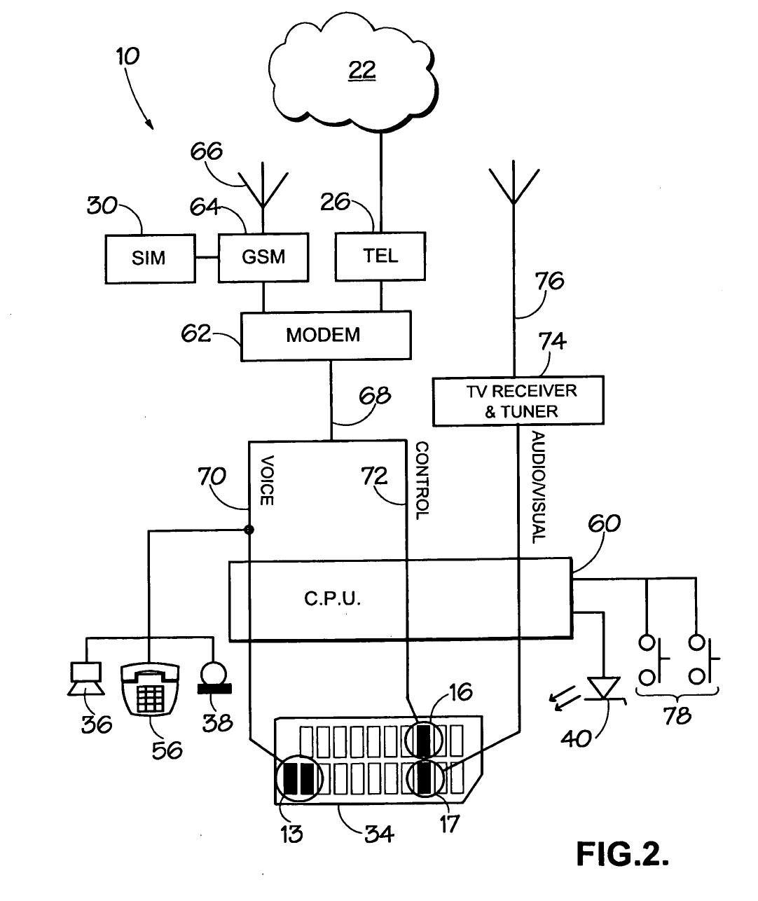

FIG. 2 is a schematic showing the configuration of the components of the set-top box of FIG. 1;

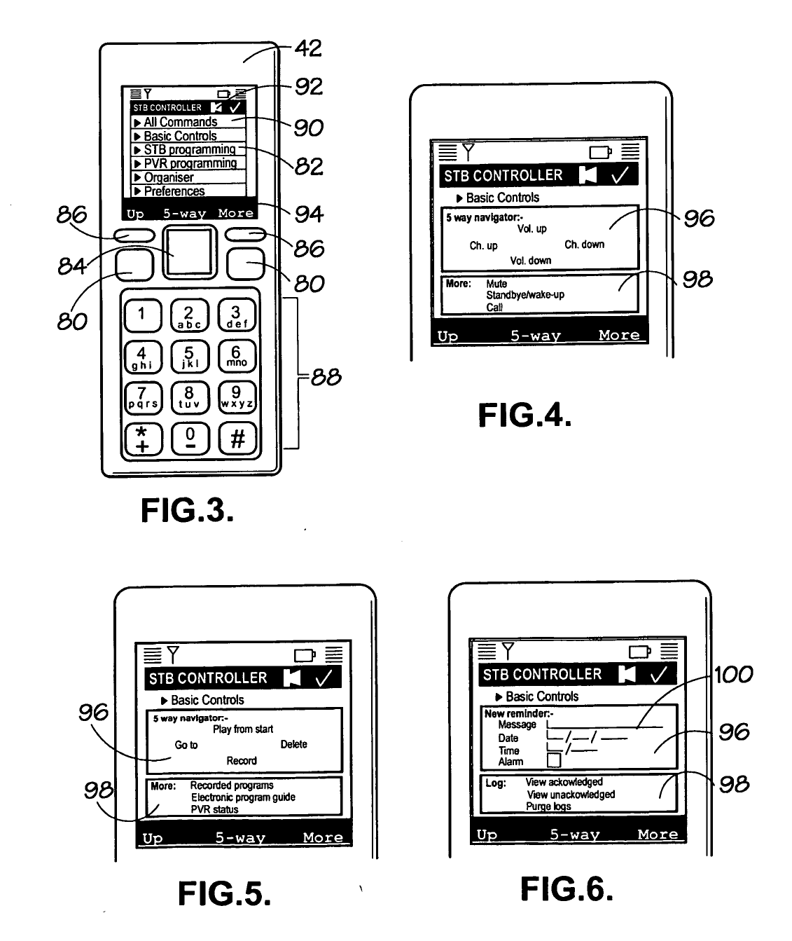

FIG. 3 is a schematic view of a mobile telephone loaded with software for controlling the local user's STB;

FIG. 4 is a schematic screenshot of the basic controls sub-menu of the remote user's telephone software;

FIG. 5 is a schematic screenshot of the PVR programming sub-menu of the remote user's telephone software; and

FIG. 6 is a schematic screenshot of the Organiser sub-menu of the remote user's telephone software.

In FIG. 1, a remote monitoring and control apparatus 10, in the form of a set-top box is provided. The set-top box has connections to a television set 12, an aerial 14 and a telephone line socket 16. Using the apparatus 10, a local user 18 can communicate with a remote user 20 via a telephone network 22.

Specifically, the set-top box 10 has various inputs and outputs as can be seen in the inset of FIG. 1. The rear face of the set-top box 10 has an aerial input socket 24 to which a terrestrial television aerial, a cable telephone network or a satellite dish can be connected. A first telephone socket 26 is provided so that the set-top box 10 can be connected to a telephone network. In addition, a landline/mobile network selector switch 28 is provided to enable the local user 18 (or installer) to select between landline and mobile telephony connections. A Subscriber Identity Module (SIM) card reader 30 is provided so that a SIM card can be used for mobile telephony connection to the telephone network 22, making the connection 26 to the landline redundant. A second telephone socket 32 is also provided to enable the local user 18 (or installer) to connect a telephone handset to the set-top box 10 for reasons that are explained below. Finally, a SCART connector (and/or a coaxial TV out connector) 34 is provide so that output signals can be displayed on the television set 12.

The set-top box 10 also comprises a speaker 36 so that the local user 18 can hear the remote user 20 speaking, and a microphone 38 so that the local uses 18 can speak to the remote user 20.

Finally, a high intensity LED 40 is provided on the top of the set-top box 10, which illuminates to warn the local user 18 of an incoming call.

In use, the remote user 20 uses a telephone 42, (in this case a mobile telephone) to call the local user 18. When the call is connected 44, the indicator LED 40 illuminates, the television volume mutes and a text message appears on the local user's television set 12 to warn of an incoming call. After a predetermined number of rings, the set-top box 10 automatically picks up the call 44 and opens a voice channel. The remote user's voice can then be heard via the built in speaker 36 or using the television's speakers 46. The local user 18 can respond by speaking normally. The local user's voice is picked-up by the microphone 38 and transmitted back to the remote user 20 via the telephone network 22. Thus, a two way conversation can take place between the local 18 and remote 20 users.

A TV sound signal is fed back to remote user via the telephone network (or broadband service) so that the remote user can confirm the TV channel selection. The sound feedback also enables the remote and local users to discuss and share enjoyment of the program.

Once connected, the set-top box also opens a control channel, which enables the remote user to user DTMF tones (generated by pressing keys on his/her telephone 42) to control the operation of the television set 12. The key stokes for different controls are predefined and are known to the remote user 20. Details of basic control key stokes are listed in Table 1 below:

TABLE 1
basic DTMF controls

| Operation | Key Stroke |
|---|---|
| Scroll channel up | 2 |
| Scroll channel down | 8 |
| Jump to channel X (e.g. channel 124) | #, X, # (e.g. #124#) |
| Increase volume | 6 |
| Decrease volume | 4 |
| Mute/un-mute volume | 5 |
| Standby/wake-up | 7 |

More complex (advanced) control functions are also possible, such as programming a connected video recorder (not shown) to start-stop recording at specific times, to begin playback, pause, rewind etc. The key strokes for these operations will depend on the functions available and the compatibility of the video equipment with the set-top box 10.

The system also utilises hidden DTMF tones (i.e. tones that do not correspond to 0-9,*,#) which are not accessible via a standard telephone handset. These hidden tones are used to add security and prevent accidental operations being carried (such as shutdown of the system), which could inconvenience the user.

The system also comprises an interactive voice response, i.e. a voice message confirming the command sent, which is fed back to remote user via the telephone or broadband service over the same telephone line.

Also shown in FIG. 1 is an alternative connection method, whereby the remote user 20 uses his or her telephone 42 to call a call centre 48. The call centre 48 has an operator 50 (either human or computer) that enables the remote user 20 to be connected to the local user 18 after satisfying certain criteria. The call centre operator 50 may ask the remote user for identity information, which it checks against data held in a security database 52. Once satisfied that the remote user has permission to contact the local user 18, the operator checks the local users subscription data in a subscription database 54. The subscription database 54 contains information about the local user 18, such as the telephone number, whether he or she has subscribed to certain service packages and, importantly, whether he or she has set any restrictions on incoming calls (e.g. “no incoming calls after 9 pm except calls from immediate family”). Once the operator 50 is satisfied that the remote user 20 is permitted to contact the local user 18, and that the local user is currently subscribed to the service, the remote user's call will be put through 44a whereupon the system operates as previously described.

Another advantage of having a call centre is that the local user can pick up a “dumb” telephone handset 56 connected to the second telephone socket 32 of the set-top box 10 and be instantly put through to the operator 50. The operator 50 can then interact with the local user 18 and carry out certain functions, such as answering queries, controlling the television set 12 and to connecting the local user 18 to a remote user 20. Providing the local user 18 with a “dumb” telephone handset 56 and an operator 50 negates the need for the local user 18 to be able to remember telephone numbers (as they will already be stored in the subscription database 54) or for the local user to be able to operate the television set's controls.

Referring now to FIG. 2, the set-top box 10 comprises a Central Processing Unit (CPU) 60 that controls the various functions. A telephony unit 61 is provided which comprises a modem 62 arranged to connect to a telephony network 22 using either a wired connection 26 or a Global Specification for Mobile Telephony Networks (GSM) module 64, a SIM card reader 30 and a microwave antenna 66. The incoming signal from the modem 68 comprises voice 70 and control 72 data. The CPU 60 is configured to separate the voice 70 and control 72 data, which it treats as separate channels. The voice data 70 is relayed to the dumb handset 56, or is split into incoming and outgoing signals and outputted and monitored on the speaker 36 and microphone 38, respectively. Where the speaker 36 is not in use, the incoming voice signals can be outputted to the television (in this case via pins 1 and 3 of the SCART plug socket 34).

Control signals 72 are coded by the CPU 60 into television-specific control signals and output to the television 12 (in this case on the fast-switching pin (16) of the SCART plug socket 60). Thus, incoming DTMF tones can be converted into control signals for controlling the television 12 (specifically the receiver of the television) as previously described. This factor may be especially used for controlling the volume of the television.

Additionally, the control signals 72 can be routed via the CPU 60 to the receiver 74 to control the operation of the receiver 74 (eg. change channels). This function is especially relevant where the receiver is adapted for receiving and de-coding encrypted signals, so that the decrypted signals can be displayed on the television 12, rather than just non-encrypted signals.

A television receiver/tuner 74 is arranged to receive television signals 76 from an antenna or satellite dish 14 and to convert them into signals that can be displayed on the TV set 12 (in this case, the signals are decoded into a composite AV signal, which outputted on pin 17 of the SCART connector plug 34).

As previously described, the set-top box 10 also has a high intensity LED 40 to warn the local user 18 of an incoming call and a plurality of push-switches 78 (preferably high-visibility buttons) to enable the local user 18 to manually accept or reject calls, or carry out other functions. Additionally or alternatively, the local user can use his/her infrared remote control not only to control the television but, also to place calls and respond to on-screen announcements.

In FIG. 3, a remote mobile telephone 42 comprises a main body 80, a screen 82, 5-way navigator buttons 84, two soft-keys 86 and a conventional alpha-numeric keypad 88. The mobile telephone 42 is pre-loaded with STB controller software that, when launched, opens a GUI having a browsable top-level menu 90 displayed on the screen 82. The GUI also displays a connection status icon 92, which indicates whether a voice channel is open between the remote user's telephone and the local user's STB, and a soft menu 94 listing actions that can be selected by the user using the soft keys 86 or the centre key of the 5-way navigator 84.

The remote user 20 can use the up/down keys of the 5-way navigator 84 to highlight any one of six control sub-menus, named “all commands”, “basic controls”, “STB programming”, “PVR programming”, “organiser” and “preferences”. In FIG. 3, the “basic controls” sub-menu is highlighted, and is opened by pressing the centre key of the 5-way navigator 84, whereupon the “basic controls” sub-menu is displayed on the screen 90, as shown in FIG. 4.

In FIG. 4, the remote user 20 can control the local user's STB 10 in one of two ways. Firstly, he/she can use the up/down/left/right keys of the S-way navigator 84 to quickly and easily control the local user's television volume or channel, as seen in a 5-way sub-sub-menu, or he/she can press the right-hand softkey 86 to select less-commonly used commands, such as “standby”, “wake-up” or “mute” as shown in a “more” sub-sub-menu 98. If the remote user 20 sees that the connection status icon 92 indicates an active connection, but gets no response from the local user 18, he can select “call” from the “more” menu, which will either cause the local user's STB or television to emit an audible alarm (e.g. to wake the local user 18) and/or a signal to a carer who can check-up on the local user 18.

Thus, the remote user 20 can converse with the local user 18, and can control the local user's STB 10 remotely.

When a control is selected and executed from any of the GUI menus, software on the remote user's telephone 42 looks-up a four-digit numerical code corresponding to the control. (For example, code “0101” may correspond to “volume up”, whereas code “0678” may correspond to “call”). The code is sent as a microsecond burst of DTMF tones over the voice channel, which short burst is barely noticeable by the local user 18.

The local user's STB 10 is also pre-loaded with receiving software that listens out for incoming microsecond bursts of DTMF tones. The receiving software contains various filters that enable the DTMF bursts to be distinguished, and isolated, from the conversation taking place between the is remote user 20 and the local user 18. The DTMF bursts are interpreted as four-digit codes, which are looked-up from a locally-stored database that contains the same code-command data as the remote user's telephone 42. Thus, incoming DTMF tones are used to control the local user's STB.

In FIG. 5, the remote user 20 has selected the “PVR programming” sub-menu from the top-level menu shown in FIG. 3. Again, the remote user 20 can quickly access and action certain commands using the 5-way navigator 48, or can access less frequently used commands from a “more” sub-sub-menu 98. Specifically, the pre-loaded software on the remote user's telephone comprises a wireless internet connection module that enables it to download Electronic Program Guide (EPG) data from a broadcaster's, or a service provider's, website. By selecting “electronic program guide” from the “more” sub-sub-menu 98, the remote user is able to download and view details of future television programs. The remote user 20 can select programs which the local user wishes to watch and designate them to be automatically switched to at the appropriate time, or automatically recorded on the local user's STB/PVR 10. The pre-loaded software then generates four-digit codes that are sent to the local user's STB 10 as microsecond bursts, which bursts are interpreted by the STB 10 and are used to appropriately program the STB/PVR 10.

Additionally, the STB 10 contains a memory device that stores information regarding which recorded programs have been watched. The remote user 20 can access and view this data by selecting “recorded programs” from the “more” sub-sub-menu 98. Similarly, the remote user 20 can check the status (amount of free space, etc.) of the PVR by selecting “PVR status” from the “more” sub-sub-menu 98.

Turning now to FIG. 6, it can be seen that the remote user 20 has opened the “organiser” sub-menu. The remote user can enter a message in the message field 100 using the alphanumeric keypad 88 of his/her mobile telephone. The remote user can also assign a date and time for the message to be displayed on the local user's television screen, and can optionally select an alarm to sound on the local user's television at the designated date and time. Once complete, the remote user transmits the message data to the local user's STB over the telephone network. For example, the remote user may be a medical practitioner and the message may be “take 100 mg of medication x”. At the allotted time, as defined by the remote user, the message “take 100 mg of medication x” flashes up on the local user's television screen. The local user can then acknowledge receipt of the message by pressing an acknowledgement button either on the STB, or on his/her telephone. The fact of acknowledgement is then sent to the remote user. The remote user can access a log of acknowledged and unacknowledged messages using the “Organiser/log” sub-sub-menu on his phone. Thus, it is possible to monitor the local user's compliance, for example with a medication regime. Such a facility may be particularly useful where the local user has a complex medication regime and/or where the local user has difficulty remembering to take his/her medication.

The invention is not limited to the details of the foregoing embodiments, for example, alternative pin outputs on the SCART plug connector may be used and/or certain functions may be redundant or not used on specific models of set-top box. The set-top box may comprise a camera so that the remote user 20 can see the local user 18 during a call, and/or a camera on the remote user's telephone 42 may enable the local user 18 to see the remote user 20 during a telephone call on the television set 12. In an alternative embodiment of the invention, the remote monitoring and control apparatus is not a set-top box, but is integrated into a television set.

In the foregoing embodiment, the set-top box is connected to the television set using a SCART lead. This need not be the case since it would be possible for the set-top box to control the television set using an infra-red transmitter that communicates with the remote control infra-red receiver of the television set.

1. A remote monitoring and control apparatus comprising:
a receiver adapted to receive one or more input signals and provide one or more output signals for displaying content on a monitor;
a telephony unit for connecting a remote telephone to a local interface using a telephony signal; and
a processing unit operatively connected to the receiver and the telephony unit, wherein
the processing unit is adapted to detect an incoming call from the remote telephone and in response thereto automatically:
i) allocate and open a voice channel of the telephony signal over which a user of the remote telephone and a user of the local interface can converse; and
ii) allocate and open a control channel of the telephony signal over which the user of the remote telephone can send control signals to control the operation of the receiver.

2. A remote monitoring and control apparatus as claimed in claim 1 wherein the output signal of the receiver is suitable for displaying content on a television or a computer screen.

3. A remote monitoring and control apparatus as claimed in claim 1 or claim 2, wherein the local interface comprises a speaker and a microphone.

4. A remote monitoring and control apparatus as claimed in claim 3, wherein the speaker is integral with a connected device.

5. A remote monitoring and control apparatus as claimed in claim 4, wherein the connected device is a television set.

6. A remote monitoring and control apparatus as claimed in any preceding claim, further comprising means for generating audible confirmation signals for confirming control signals sent from the remote user to the local user.

7. A remote monitoring and control apparatus as claimed in claim 6, wherein the confirmation signals comprise pre-recorded voice messages.

8. A remote monitoring and control apparatus as claimed in any of claims 5 to 7, further comprising an infra-red transmitter for transmitting infra-red control signals to an infra-red receiver of the television set or receiver.

9. A remote monitoring and control apparatus as claimed in claim 8, wherein the infrared transmitter is configured to enable the local user to interact with, and to place outgoing telephone voice calls via, and/or respond to on-screen announcements displayed by, the receiver

10. A remote monitoring and control apparatus as claimed in any preceding claim, wherein the processing unit is adapted to announce incoming calls using an audible and/or a visible signal.

11. A remote monitoring and control apparatus as claimed in claim 10, wherein the audible signal comprises a buzzer and/or muting a connected television and/or outputting an audible signal to the speakers of a connected television.

12. A remote monitoring and control apparatus as claimed in claim 10, wherein the visible signal comprises a light and/or displaying a text message on the screen of a connected television or computer.

13. A remote monitoring and control apparatus as claimed in any preceding claim, further comprising means to manually override the automatic allocation and opening of the voice and/or control channels.

14. A remote monitoring and control apparatus as claimed in any preceding claim, wherein the processing unit is adapted to designate a portion of the available bandwidth of the telephony signal for control signals.

15. A remote monitoring and control apparatus as claimed in any of claims 1 to 13, wherein the processing unit is adapted to compress control signals and to interlace the compressed control signals with the voice signals using the available bandwidth of the telephony signal.

16. A remote monitoring and control apparatus as claimed in any of claims 1 to 13, wherein the control signals are sent as audible DTMF tones over the voice channel.

17. A remote monitoring and control apparatus as claimed in any of claims 1 to 13, wherein the control signals are sent as hidden DTMF tones over the voice channel.

18. A remote monitoring and control apparatus as claimed in any preceding claim, wherein the telephony unit is a mobile telephony unit.

19. A remote monitoring and control apparatus as claimed in any preceding claim, wherein the processing unit is adapted to output the output signals to a SCART plug socket.

20. A remote monitoring and control apparatus as claimed in any preceding claim, further comprising a camera to enable the remote user to see the local user during a call.

21. A set-top box comprising a remote monitoring and control apparatus according to any preceding claim.

22. A television set comprising a remote monitoring and control apparatus according to any of claims 1 to 20.

23. A remote monitoring and control apparatus as claimed in any preceding claim, wherein the remote' telephone is comprises control software adapted to facilitate interaction between the remote user and the local user's receiver.

24. A remote monitoring and control apparatus as claimed in claim 23, wherein the control software comprises a Graphical User Interface comprising browsable menus displayable on a screen of the remote telephone.

25. A remote monitoring and control apparatus as claimed in claim 24, wherein the or each browsable menu contains a plurality of selectable commands, each command being representative of a control function of the local user's receiver.

26. A remote monitoring and control apparatus as claimed in claim 25, wherein the software comprises a database of DTMF codes corresponding to each command.

27. A remote monitoring and control apparatus as claimed in claim 26, wherein the software is arranged to transmit the DTMF codes a microsecond bursts over the voice channel.

28. A remote monitoring and control apparatus as claimed in any preceding claim, wherein the local user's receiver comprises receiving software that listens out for incoming microsecond bursts of DTMF tones.

29. A remote monitoring and control apparatus as claimed in claim 28, wherein the receiving software comprises a filter that enables the DTMF bursts to be distinguished, and isolated, from a conversation taking place between the remote user and the local user.

30. A remote monitoring and control apparatus as claimed in any of claims 26 to 29, wherein the local user's receiver comprises a database that contains the same code-command data as the remote user's telephone.

31. A remote monitoring and control apparatus as claimed in any of claims 28 to 30, wherein the remote user's software is adapted to transmit a message displayable on the local user's monitor.

32. A remote monitoring and control apparatus as claimed in claim 31, wherein the remote user's software is adapted to transmit a message displayable on the local user's monitor at a designated date and/or time.

33. A remote monitoring and control apparatus as claimed in claim 31 or claim 32, wherein the local user's receiver comprises means for acknowledging receipt of the message and means for transmitting the acknowledgement to the remote user's telephone.

34. A remote monitoring and control apparatus substantially as hereinbefore described, with reference to and as illustrated in the accompanying drawings.

35. A set-top box substantially as hereinbefore described, with reference to and as illustrated in FIGS. 1 and 2 of the accompanying drawings.

36. Software substantially as hereinbefore described, with reference to and as illustrated in FIGS. 3 to 6 of the accompanying drawings.
